(19) United States
(12) Patent Application Publication
(10) Pub. No.: US 2005/0130510 A1
(43) Pub. Date: Jun. 16, 2005

(54) Electrical card connector

(76) Inventors: Oisheng Zheng, Kunsan (CN); ChenHua Liang, Kunsan (CN); Bo Chen, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 11/001,859

(22) Filed: Dec. 1, 2004

(30) Foreign Application Priority Data
Dec. 16, 2003 (CN) 2003201233913

(51) Int. Cl. H01R 13/62

(52) U.S. Cl. 439/862

(57) ABSTRACT

An electrical card connector (100) is mounted on a circuit board for mating with a memory card. The card connector includes an insulative housing (1) and a number of conductive contacts (2) fixed in the hosing. The housing defines a number of recesses (13) and cavities (14). Each recess has a fixing wall (131) in a lower portion thereof. The contacts are received in corresponding cavities and each includes a body portion (21), a resilient deflectable contact arm (22) with one end connecting with the body portion, a first fixing portion (23) extending upwardly through a corresponding recess from a first end of the body portion and bent to abut against the fixing wall, and a connection end (25) extending from a second end of the body portion adapted to electrically contact the circuit board. The contact arm has a contact portion projecting through the corresponding cavity for engaging with the memory card.

### BACKGROUND OF THE INVENTION

1. Field of the Invention

The present invention generally relates to electrical card connectors used in electronic appliances such as a palmtop computer and a cellular phone, and more particularly to a Subscriber Identity Module (SIM) card connector.

2. Description of the Related Art

As is well-known, chip or smart cards are used for various purposes, for instance as prepaid telephone cards. Such a telephone card allows the purchaser to insert the card into a public telephone and then make telephone calls equivalent to the amount of money paid for said telephone card. Chip cards are also used to identify members of, for instance, a health organization and so on. SIM cards derive their name form the words “subscriber identity module”. SIM cards are frequently used in so-called cell phones, for instance to identify a subscriber of the respective telephone company.

As the size of such pocket-size cellular phones decreases, there is a constant demand to make electrical components in the cellular phones smaller and lighter in weight. U.S. Pat. No. 6,000,969 issued to Reichardt et al. on Dec. 14, 1999 discloses a card connector comprising an insulating body and a plurality of conductive contacts received in the housing. Each contact has contact end projecting beyond the insulating body, a connection end and a guide portion extending between the connection end and the contact end. The connection ends of the contacts resting under prestress on a bottom surface of the insulating for being soldered to a circuit board.

However, the Reichardt contacts are mounted on the insulating body only by the connection ends abutting against corresponding portions of the housing, which increase the difficulty of orientation during assembling the card connector to the circuit board. Moreover, it is difficult to accurately position the contacts in the housing since the guiding portions of the contacts are received in the insulating body without retention, thus rendering contact area of each contact in different surfaces. Therefore, electrically connections between the contacts and a memory card are unreliable.

Hence, an electrical card connector with reliable contacts is needed to overcome the foregoing shortcomings.

### BRIEF SUMMARY OF THE INVENTION

A main object of the present invention is to provide an electrical card connector having reliable conductive contacts.

An electrical card connector is mounted on a circuit board for mating with a memory card. The card connector includes an insulative housing and a number of conductive contacts fixed in the hosing. The housing has an upper and bottom faces. A number of recesses and cavities are defined the upper face and communicating with each other in the bottom face. Each recess has a fixing wall in a lower portion. The contacts are received in corresponding cavities and each includes a body portion, a resilient deflectable contact arm with one end connecting with the body portion, a first fixing portion extending upwardly through a corresponding recess from a first end of the body portion and bent to abut against the fixing wall, and a connection end extending from a second end of the body portion adapted to electrically contact the circuit board. The contact arm has a contact portion projecting through the corresponding cavity and above the upper face for engaging with the memory card.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of an electrical card connector according to the present invention;

FIG. 2 is another perspective view of FIG. 1, taken from bottom aspect;

FIG. 3 is an exploded view of FIG. 1, wherein conductive contacts are in their former state;

FIG. 4 is another perspective view of an insulative housing shown in FIG. 3, taken from bottom aspect;

FIG. 5 is a cross-sectional view of the insulative housing taken along line 5-5 of FIG. 3;

FIG. 6 is a cross-sectional view of the electrical card connector taken along line 6-6 of FIG. 1, but showing the contacts in their former state; and

FIG. 7 is anther cross-sectional view of FIG. 6, but showing the contacts in their final state.

### DETAILED DESCRIPTION OF THE INVENTION

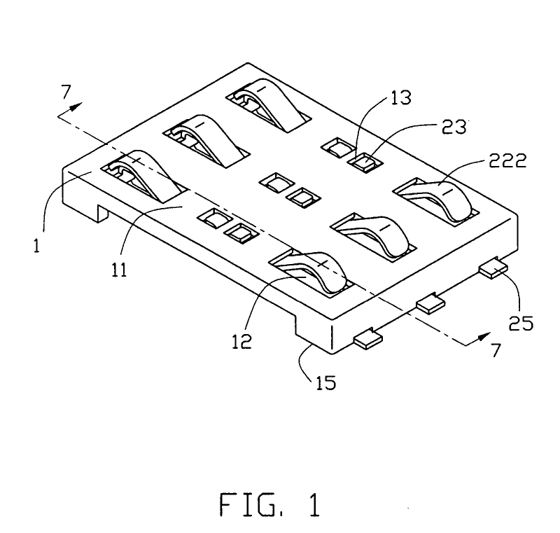

Referring to FIGS. 1, 2 and 3, an electrical card connector 100 of the present invention adapted for installing a memory card, such as a SIM card therein is provided for mounting on a printed circuit board (PCB, not shown) of an electronic appliance, such as a cellular phone. The electrical card connector 100 comprises an insulative housing 1 and a plurality of conductive contacts 2 received in the housing 1. The conductive contacts 2 are arranged in two rows, with the contacts 2 in one row being turned 180 degrees about a vertical axis with respect to the contacts 2 of the other row.

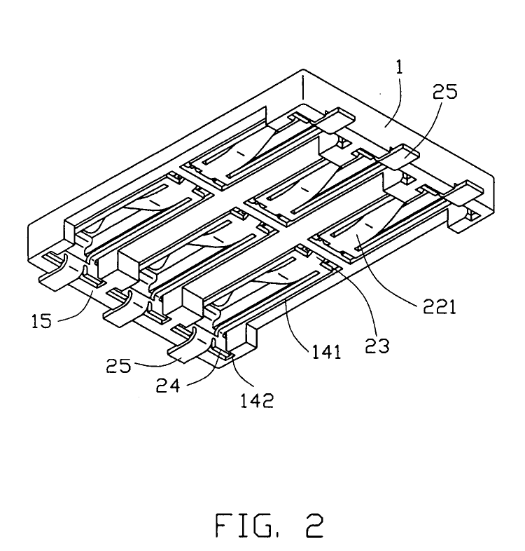

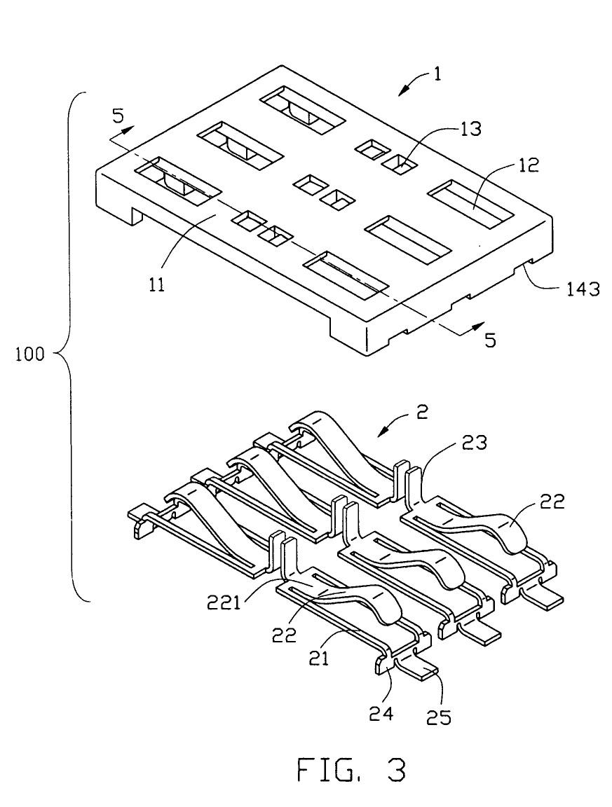

As best shown in FIG. 3 in conjunction with FIGS. 1 and 2, each conductive contact 2 is stamped from a metal sheet and comprises a body portion (not labeled), a resilient deflectable contact arm 22 stamped upwardly from the body portion, a first fixing portion 23, a second fixing portion 24 and a connection end 25. The body portion is a substantially rectangular frame and includes a pair of spaced beams 21 joined together at both their front and rear ends. The contact arm 22 lies between the beams 21 and comprises a base portion 221 extending rearwardly and upwardly from the front end of the body portion, and a convexly curved contact portion 222 in a free end thereof for engaging with a memory card pad (not shown) of the memory card. The first fixing portion 23 extends upwardly from the front end of the body portion, and the second fixing portion 24 extends downwardly from the rear end of body portion. The connection end 25 is positioned in a middle portion of the second fixing portion 23 and bends outwardly to be soldered on the PCB.

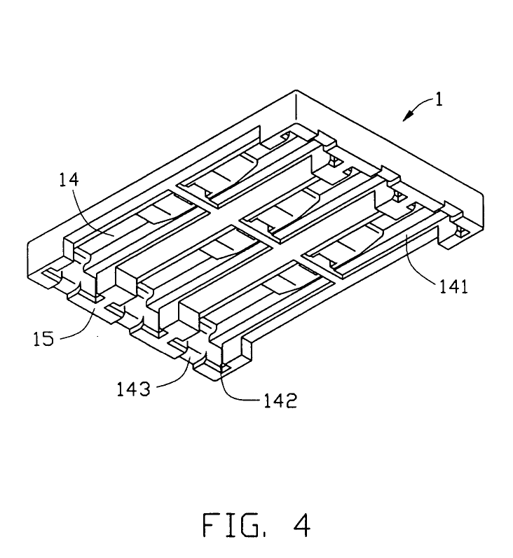

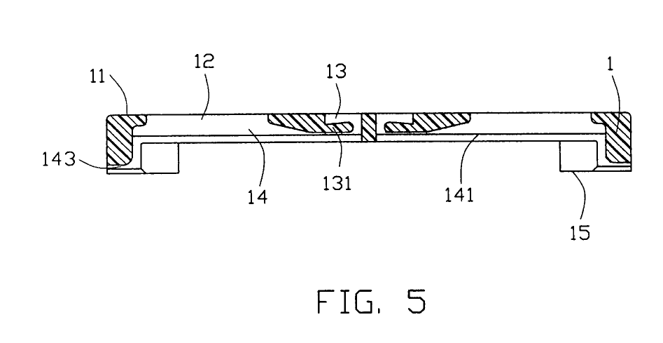

Referring to FIGS. 3, 4 and 5, the insulative housing 1 is substantially lower profile rectangular shaped and has an upper face 11 and a bottom face 15. The housing 1 comprises two rows of longitudinally-extending slots 12 in the upper face 11, two rows of upwardly-opening recesses 13 in a middle portion of the upper face 11, and a plurality of downwardly-opening cavities 14 in the bottom face 15 communicating with corresponding slots 12 and recesses 13. Each recess 13 provides a fixing wall 131 in a lower portion thereof for supporting the front fixing portion 23 of the contact 2. Each cavity 14 provides an L-shaped stepped supporting portion 141 for supporting the beams 21 of the contact 2, a groove 142 in the bottom face 15 for receiving the second fixing portion 24, and a cutout 143 proximate the groove 142 and communicating with the groove 142 for accommodating the connection end 25 of the contact 2.

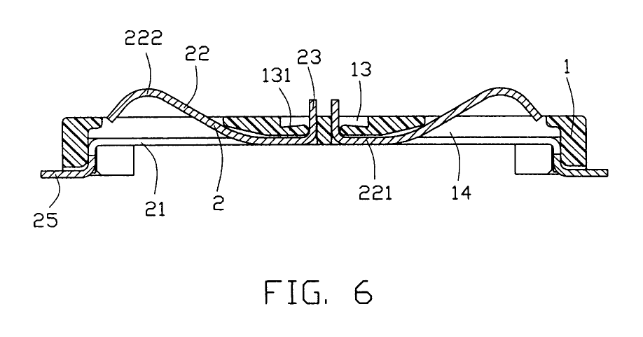

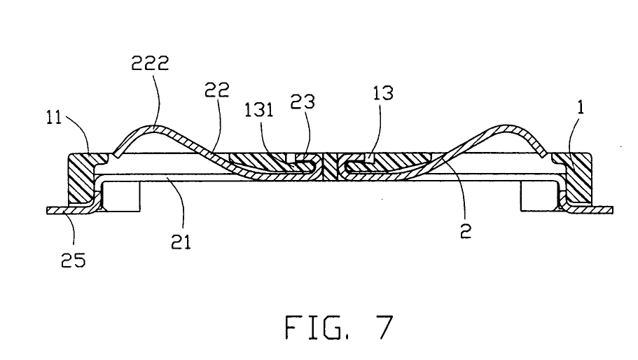

Referring to FIGS. 6 and 7 in conjunction with FIGS. 1 and 2, in assembly, the conductive contacts 2 are embedded in the housing 1 from the cavities 14. The beams 21 of the contacts 2 are positioned on the supporting portions 141 of the housing 1. The convexly curved contact portion 222 of the contact arm 22 of each contact 2 upwardly projects beyond a corresponding slot 12 of the housing 1 for engaging with the memory card. The second fixing portion 24 of each contact 2 lies in the groove 142 of the housing 1. The connection end 25 of each contact 2 is held in the cutout 143 of the housing 1. The first fixing portion 23 of each contact 2 extends beyond the recess 13 and is bent downwardly to abut against a top surface of the fixing wall 131. Therefore, the contacts 2 are securely fixed in the housing 1. It should be noted that a top surface of the bent first fixing portion 23 is no higher than the upper face 11 of the housing 1.

It is to be understood, however, that even though numerous, characteristics and advantages of the present invention have been set fourth in the foregoing description, together with details of the structure and function of the invention, the disclosed is illustrative only, and changes may be made in detail, especially in matters of shape, size, and arrangement of parts within the principles of the invention to the full extent indicated by the broad general meaning of the terms in which the appended claims are expressed.

1. An electrical card connector adapted to be mounted on a circuit board for a memory card, comprising:
an insulative housing including an upper and bottom faces, a plurality of contact-receiving cavities extending from the bottom face to the upper face, a plurality of recesses extending from the upper face toward the lower face and communicating with the contact-receiving cavities, a fixing wall projecting into a lower portion of each recess; and
a plurality of conductive contacts positioned in the contact-receiving cavities of the housing, each contact including a body portion, a resilient deflectable contact arm with one end connecting with the body portion, a first fixing portion extending upwardly through a corresponding recess from a first end of the body portion and bent to abut against the fixing wall, and a connection end extending from a second end of the body portion adapted to electrically contact the circuit board, the contact arm having a contact portion projecting through the contact-receiving cavity and above the upper face for engaging with the memory card.

2. The electrical card connector according to claim 1, wherein the body portion is a substantially rectangular frame and includes a pair of spaced beams joined together at the first and second ends thereof.

3. The electrical card connector according to claim 2, wherein the contact arm lies between the beams with one end thereof joined together with the beams, and the contact portion is substantially convexly curved at a free end of the contact arm for engaging with the memory card.

4. The electrical card connector according to claim 2, wherein the first fixing portion extends upwardly and backwardly.

5. The electrical card connector according to claim 1, wherein each contact-receiving cavity includes a longitudinally-extending slot in the upper face and a downwardly-opening cavity in the bottom face communicating with the slot.

6. The electrical card connector according to claim 5, wherein each downwardly-opening cavity provides an L-shaped stepped supporting portion supporting the body portion of each contacts.

7. The electrical card connector according to claim 1, wherein a top surface of the bent first fixing portion is lower than the upper face of the housing.

8. The electrical card connector according to claim 1, wherein a top surface of the bent first fixing portion is substantially coplanar with the upper face of the housing.

9. The electrical card connector according to claim 1, wherein the first fixing portion of the contact is bent into a loop-shape.

10. The electrical card connector according to claim 1, wherein the first fixing portion of the contact rests under prestress upon the fixing wall of the housing.

11. The electrical card connector according to claim 1, wherein the contact includes a second fixing portion extending downwardly from the second end of the body frame, and wherein the housing defines a groove in a bottom face accommodating the second fixing portion therein.

12. The electrical card connector according to claim 11, wherein the connection end is positioned in a middle portion of the second fixing portion and bends outwardly to be mounted on the circuit board.

13. The electrical card connector according to claim 11, wherein the housing defines a cutout proximate the groove, and the connection end is partially received in the cutout

14. An electrical card connector adapted to be mounted on a circuit board, comprising:
an insulative housing; and
a plurality of conductive contacts positioned in the housing, each contact including a pair of spaced beams located in the housing, a resilient deflectable contacting arm lying between the beams and partially projecting beyond the housing, a first fixing portion and a connection end, the beams joined together at front ends thereof, the first fixing portion extending from the one ends of the beams and bent into loop-shaped to rest under prestress upon the housing, the connection end adapted to electrically contact the circuit board.

15. An electrical connector comprising:
an insulative housing defining opposite upper and bottom faces with a plurality of contact-receiving cavities extending therethrough;
an upside-down L-shaped recess formed at an inner end of each of the passageway;
a retention cavity communicatively extending vertically from an outer end of each of the passageway;
a plurality of terminals upwardly, from the bottom face, inserted into the corresponding contact-receiving cavities, respectively, each of said terminals including:
a main body horizontally received in said contact-receiving cavity with a contacting portion extending upwardly above the upper face;
an upside-down L-shaped first fixing portion located at an inner end of the main body and received in the upside-down L-shaped recess; and
another fixing portion located at an outer end of the main body and received in the retention cavity.

16. The connector as claimed in claim 15, wherein both said upside-down L-shaped recess and said retention cavity are exposed to the bottom face while only said upside-down L-shaped recess is exposed to the upper face and said retention recess is not.

17. The connector as claimed in claim 15, wherein a soldering portion extends from said another fixing portion.

18. The connector as claimed in claim 15, wherein said main body includes a pair of spaced beams with said contacting portion extending therebetween.
